(19) United States
(12) Patent Application Publication
(10) Pub. No.: US 2013/0214441 A1
(43) Pub. Date: Aug. 22, 2013

(54) SECONDARY AQUEOUS DISPERSIONS OF BIODEGRADABLE DIBLOCK COPOLYESTERS, PROCESSES FOR PREPARATION THEREOF AND USE THEREOF

(71) Applicants: Andreas Greiner, Amoneburg (DE); Seema Agarwal, Marburg (DE); Kathrin Bubel, Wittingen (DE)

(72) Inventors: Andreas Greiner, Amoneburg (DE); Seema Agarwal, Marburg (DE); Kathrin Bubel, Wittingen (DE)

(73) Assignee: PHILLIPS-UNIVERSITÄT MARBURG, Marburg (DE)

(21) Appl. No.: 13/816,701

(22) PCT Filed: Aug. 12, 2011
(86) PCT No.: PCT/EP2011/063950

§ 371 Date: Apr. 9, 2013

(30) Foreign Application Priority Data
Aug. 13, 2010 (EP) 10172840.0

(51) Int. Cl. C08L 67/02

(52) U.S. Cl. CPC C08L 67/02
USPC 264/8; 524/604

(57) ABSTRACT

The present invention provides aqueous stable suspensions of biodegradable diblock copolyesters and a method for their production. The diblock copolyesters comprise one block of an aliphatic polyester and one block of a polyethylene oxide.

Suspensions according to the present invention are suitable to be used as biodegradable viscosity modifiers, compatibilizers in blends, as glues, varnishes, paper additives, flame retardants, impact modifiers and hazers of transparent plastics, and for the production of biodegradable sheets, films, fibers, plates, vessels, tubes and capillaries for transport or packaging purposes. Furthermore, the suspensions according to the present invention are suitable to be used for the production of nano- and microfibers and nano- and microfiber nonwovens with non-oriented or oriented fibers by means of electrospinning.

### BACKGROUND OF THE INVENTION

1. Field of the Invention

The present invention relates to the fields of macromolecular chemistry, polymer chemistry, microbiology and material sciences.

2. Brief Description of Related Technology

Electrospinning certainly represents one of the most important current methods in science and technology for the production of polymer micro- and nanofiber non-wovens, wherein micro- and nanofibers are to be understood to mean short or long fibers (from just a few micrometers and more) with diameters from 0.05-10 micrometers. It may also refer to fibers with different fiber diameters, e.g. with bimodal fiber diameter distribution. The respective production methods are generally known.

Electrospinning is suitable to take place from melt or solution. The electrospinning of non-aqueous polymer solutions is critical, because the required solvents are frequently toxic, irritant, flammable, explosive, harmful to health, etc. Thus, only such dangerous solvents are suitable to be used for the production of micro and nanofiber wovens of biodegradable copolyesters, because safe solvents, such as water, are not generally solvents for copolyester. While there are indeed copolyesters which are water-soluble, and electrospinning should also be possible with these copolyesters, the resulting electrospun copolyester fibers are also water-soluble again, which makes them unusable for many applications in medicine, pharmaceutics and agriculture.

As such, WO 2006/023388 A2 describes biodegradable diblock copolyesters, which comprises a reverse thermal gelation. Biodegradable diblock copolymers of the type AB are described. A is thereby a biodegradable, hydrophobic block that is suitable, inter alia, to be a polyester, and has a portion of 61-85 wt.-% across the entire polymer. B is a biocompatible, hydrophilic block comprising a monofunctional polyethylene glycol with a mean molecular weight of between 50 and 5,000 dalton, which comprises reverse thermal gelation. The diblock copolymer has an average molecular weight of 450 to 15,000 dalton and has a water solubility of 3 to 60%.

It is known that aliphatic copolyesters are biodegradable. It is also known that such biodegradable copolyesters are suitable to be dispersed in water, i.e. non-water-soluble copolyesters are not dissolved on a molecular level in water, but through the dispersal of small particles in water, often with the help of surfactants. Particle diameters of some 10 nanometers up to some hundred nanometers are typically achieved (often, the particles are spherical or almost spherical) and solid content of 1-3 wt.-%.

As such, JP 2008-248016 A discloses fine particles of a slightly crystalline copolyester resin and a method for its production. The copolyester resin is produced from monomers of aromatic or aliphatic dicarboxylic acids as well as of a glycol component. Low amounts of a triple or multivalent carboxylic acid and/or a polyhydric alcohol are suitable to be added optionally. The copolyester resin is warmed up and mixed with a water-soluble resin. The water-soluble resin is then dissolved in water and is washed repeatedly with water in order to remove the water-soluble resin. An aqueous suspension of the copolyester resin, which is only slightly soluble, is then prepared, warmed up and treated with ultrasound.

Such aqueous suspensions are not suitable for the production of analog nano- and microfiber fabric. It is also known that aqueous suspensions of polystyrenes and polyacrylates together with low amounts of water-soluble polymers, e.g. poly(vinylalcohol) or poly(ethyleneoxide), nano- and microfiber wovens are suitable to be obtained through electrospinning; however, such polymers are not biodegradable.

### SUMMARY

The present invention overcomes the disadvantages of the state of the art by providing stable, aqueous suspensions of non-water-soluble, biodegradable diblock copolyesters for the first time. The concentration of the diblock copolyesters in the suspension is at least 10 wt.-%.

The suspensions according to the present invention comprise aliphatic diblock copolyesters which comprise at least one chain segment of an aliphatic polyester and segments of a polyethylene glycol. Aliphatic esters are used which had been formed via condensation of a saturated alkane dicarboxylic acid and an alkanediol. The suspensions are produced by firstly dissolving particles of the biodegradable diblock copolyesters in a polar aprotic solvent; this solution is subsequently mixed with water, the aprotic solvent is removed, and the suspension obtained in this way is dialyzed against a water-soluble polymer. A nonionic surfactant is suitable to be optionally added to the secondary suspensions of the biodegradable diblock copolyesters.

The aim of the present invention is to provide aqueous stable suspensions of biodegradable diblock copolyesters, as well as methods for the production of these suspensions, wherein the suspensions comprise sufficiently high portions of solid content, so that water-insoluble nano- and microfiber wovens with non-oriented or oriented fibers are formed.

Suspensions according to the present invention are suitable to be used as biodegradable viscosity modifiers, compatibilizers in blends, as glues, varnishes, paper additives, flame retardants, impact modifiers and hazers of transparent plastics, and for the production of biodegradable sheets, films, fibers, plates, vessels, tubes and capillaries for transport or packaging purposes. Furthermore, the suspensions according to the present invention are suitable to be used for the production of nano- and microfibers and nano- and microfiber nonwovens with non-oriented or oriented fibers by means of electrospinning.

### BRIEF DESCRIPTION OF THE DRAWINGS

FIG. 1 is a plot illustrating the particle size distribution of a copolyester (polyhexylene-adipate-block-methoxy-polyethylene-glycol (“PHA-MPEG”) suspension;

FIG. 2 is a plot illustrating the particle size distribution of a more concentrated copolyester (PHA-MPEG) suspension;

FIG. 3 illustrates (left-hand side image) fibers obtained after electrospinning a concentrated diblock copolyester (PHA-MPEG) suspension with a solution of polyethylene oxide and (right-hand side image) and after water treatment;

FIG. 4 is a schematic drawing of a device suitable for carrying out the electrospinning method; and,

FIG. 5 is a plot illustrating the particle size distribution of a self-stabilized copolyester (PHA-MPEG) suspension.

### DETAILED DESCRIPTION

For the first time, the present invention provides stable, secondary, aqueous suspensions of biodegradable diblock copolyesters. Furthermore, a method for producing the suspensions according to the present invention is provided. The suspensions according to the present invention are suitable to be used for the electrospinning of diblock copolyesters.

The aim to provide aqueous stable suspensions of biodegradable diblock copolyesters is achieved according to the present invention through secondary aqueous suspensions comprising at least one water-insoluble biodegradable aliphatic diblock copolyester in accordance with formula (I)

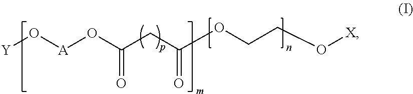

wherein
A=a linear or branched alkyl group with 3 to 12 carbon atoms
p=1 to 14
m=10 to 5,000
n=10 to 500
X=H, an alkoxide, a linear, branched or cyclic alkyl group with 1 to 20 carbon atoms or a phenyl group
Y=H, an alkoxide, a linear, branched or cyclic alkyl group with 1 to 20 carbon atoms, a carboxylate, carboxylic acid residue, an ester, thioester
   wherein
   the at least one diblock copolyester comprises one block of an aliphatic polyester and one block of a polyethylene oxide, and
   the solid content of the at least one diblock copolyester in the suspension amounts to at least 10 wt.-%, and
   the melting point of the at least one diblock copolyester is between 35° C. and 70° C., and
   the mass of the polyethylene oxide block in the at least one diblock copolyester amounts to between 500 and 10,000 dalton.

The stable, aqueous secondary suspensions according to the present invention, the method for their production, and the use of these suspensions are explained hereinafter.

The invention is not limited to one of the embodiments described hereinafter; rather, it is suitable to be modified in various different ways.

All of the characteristics and advantages originating from the claims, description and figures (including constructive details, spatial arrangements and processing steps) are suitable to be essential to the invention, both in themselves and in the most various combinations.

Surprisingly, it was found that aqueous suspensions of aliphatic diblock copolyesters, which comprise one block of an aliphatic polyester and one block polyethylene oxide (also called polyethylene glycol in the event of short chains), are suitable to be electrospun into water-stable nano- and microfiber wovens if the solid content amounts to at least 10 wt.-% of the block copolyesters in the aqueous suspension.

It hereby has to be stated that the present invention does not refer to aqueous solutions of water-soluble polyesters, but to aqueous suspensions of water-insoluble polyesters. In particular, diblock copolyesters with a molecular solubility in water of less than 1% are referred to as water-insoluble diblock copolyesters in the sense of the present invention.

In the case of diblock copolymers, two blocks A and B are present, wherein A and B stand, in the present case, for at least one chain segment of an aliphatic polyester and one polyethylene oxide block. “Segment” thereby refers to a chain of several repeating units. Persons skilled in the art understand “repeating unit” to be the smallest constitutional unit of a polymer whose repetition results in a regular polymer. In the formula (I) above, the partial structure in square brackets and referred to with index m indicates the repeating unit of the ester, and the partial structure in square brackets referred to with index n represents the repeating unit of the polyethylene oxide. If there is more than one chain segment of an aliphatic ester, then this is a polyester, and A stands for a polyester block. Several chain segments of ethylene oxide form therefore a polyethylene oxide. “Polyester block” is hereinafter referred to independently of the amount of chain segments of the aliphatic ester.

Apart from the chain segment of an aliphatic polyester, diblock copolyesters to be used according to the present invention comprise at least one segment of polyethylene oxide; this is also referred to as polyethylene glycol in the event of short chains.

A dispersion in the sense of the present invention refers to—in accordance with textbook knowledge—a mixture of at least two phases which are not suitable to be mixed with one another, wherein one of the at least two phases is liquid. Depending on the aggregate state of the second or further phase, dispersions are divided into aerosols, emulsions and suspensions, wherein the second or further phase is gaseous in the case of aerosols, liquid in the case of emulsions and solid in the case of suspensions. Suspensions are used in the method according to the present invention. The colloidal polymer suspensions to be used preferably according to the present invention are referred to as latex in technical terminology.

Primary suspensions or “primary lattices” are the direct result of heterophase polymerizations. Primary aqueous (polymer) suspensions are primarily formed via emulsion polymerization, i.e. the particles are formed during the synthesis of the polymer molecules in water. Such suspensions were already used successfully for electrospinning; however, they are not known for biodegradable polymers.

Secondary suspensions are produced by reacting polymers obtained in any other way into the dispersed state. So called “artificial lattices” are obtained by dispersing a polymer or a solution of a polymer in water. If a polymer solution is used, the emulsion formed at first is suitable to be reacted by way of example through vaporization of the solvent, in a further step, into a polymer suspension.

In the formation of the secondary suspensions, the polymer molecules—in contrast to the primary suspension—are already present. However, polymerization no longer takes place. In the formation of the secondary suspensions, the polymer molecules—in contrast to the primary suspension—are already present. However, polymerization no longer takes place.

When “suspensions” are mentioned in the following, this term—unless otherwise specified—refers to secondary aqueous suspensions in accordance with the definition above.

Within the context of the present invention, “stable” is understood to mean that the secondary aqueous suspension according to the present invention is thermodynamically stable, i.e. that there is no tendency for coagulation during at least two days. Coagulation is the storing together of individual polymer particles into more compact structures (the coagulum) and the phase separation (precipitation formation) related thereto.

The suspension according to the present invention comprises aliphatic diblock copolyesters which comprise at least one chain segment of an aliphatic polyester and segments of a polyethylene glycol. It is known that esters are formed via condensation of an alcohol and a carboxylic acid.

According to the present invention, aliphatic esters are used which had been formed via condensation of a saturated alkane dicarboxylic acid and an alkanediol. The alkane dicarboxylic acid hereby comprises 3 to 16 carbon atoms and the alkanediol 3 to 12 carbon atoms.

Schematically, the diblock copolyesters to be used according to the present invention are suitable to be represented as follows:

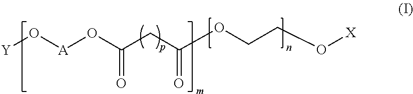

wherein
A=a linear or branched alkyl group with 3 to 12 carbon atoms
p=1 to 14
m=10 to 5,000
n=10 to 500
X=H, an alkoxide, a linear, branched or cyclic alkyl group with 1 to 20 carbon atoms or a phenyl group
Y=H, an alkoxide, a linear, branched or cyclic alkyl group with 1 to 20 carbon atoms, a carboxylate, carboxylic acid residue, an ester, a thioester.

In formula (I), the group —(C═O)—(CH₂)ₚ—(C═O)—, wherein p amounts to between 1 and 14, is derived from an aliphatic dicarboxylic acid with a total of 3 to 16 carbon atoms.

A represents a linear or branched alkyl group with 3 to 12 carbon atoms. The group —O-A-O— in formula (I) derives from an alkanediol. The linear or branched alkylene group is an ethylene, propylene, butylene, pentylene, hexylene, heptylene, octylene, nonylene, decylene, undecylene or dodecylene group. It is known that an ethylene group necessarily has to be linear, whilst the other alkylene groups indicated are suitable to be linear or branched.

If X and/or Y is an alkoxide, then the cation of the alkoxide is advantageously an alkaline or an alkaline earth cation, by way of example a lithium, sodium, calcium or calcium cation.

If X and/or Y is or are a linear and branched alkyl group with 1 to 20 carbon atoms, then this is selected from methyl, ethyl, n-propyl, isopropyl, 1-butyl, 2-butyl, tert-butyl, 1-pentyl, 2-pentyl, 3-pentyl, 3-methylbutyl, 2,2-dimethylpropyl, and all the isomers of hexyl, heptyl, octyl, nonyl, decyl, undecyl and dodecyl, tridecyl, tetradecyl, pentadecyl, hexadecyl, heptadecyl, octadecyl, nonadecyl and eicosyl.

It is known to persons skilled in the art that cyclic alkyl groups have to comprise at least three carbon atoms. Within the context of the present invention, cyclic alkyl groups advantageously comprise propyl, butyl, pentyl, hexyl, heptyl and octyl rings. In the context of the present invention, a cyclic alkyl group is selected from the annular alkyl groups mentioned which do not carry any further substituents and from the annular alkyl groups which, for their part, are bound to one or several acyclic alkyl groups. In the case of the latter, the binding of the cyclic alkyl group X or Y, respectively, to the oxygen atom in accordance with the formula above is suitable to occur via a cyclic or an acyclic carbon atom of the cyclic alkyl group. According to the above definition of the term “alkyl group”, cyclic alkyl groups also comprise a total of 20 carbon atoms maximum.

If Y is a carboxylic acid residue, then this is the residue of an aliphatic or aromatic carboxylic acid with 1 to 16 carbon atoms, wherein this residue is bound via an arbitrary carbon atom of the carboxylic acid, with the exception of the carboxyl carbon atom, to the polymer chain. If Y is a carboxylate, then the carboxylic group of the carboxylic acid residue above is present in protonated form. In this case, counterion is an alkaline or alkaline earth cation, by way of example, a lithium, sodium, calcium or calcium cation.

If Y is an ester, then the residue of an aliphatic or aromatic carboxylic acid with 1 to 16 carbon atoms is bound via its carbonyl group to the oxygen atom of the polymer chain.

If Y is a thioester, then a residue of an aliphatic or aromatic thiocarboxylic acid with 1 to 16 carbon atoms is bound via its thiocarbonyl group to the oxygen atom of the polymer chain.

Advantageously, Y is a linear, branched or cyclic alkyl group and X a linear, branched or cyclic alkyl group or a phenyl group. X is particularly preferably a methyl group.

In an advantageous embodiment, the alkane dicarboxylic acid is a 1,ω-alkane dicarboxylic acid selected from malonic acid, succinic acid, glutaric acid, adipic acid, pimelic acid, suberine acid (also known as suberic acid), azelaic acid, sebacic acid, dodecanoic acid, brassylic acid, tetradecanoic and thapsia acid. Adipic acid is particularly advantageous.

In another advantageous embodiment, the alkanediol is selected from 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol. 1,6-hexanediols is particularly advantageous.

Aliphatic esters which were formed via polycondensation of one of the above-mentioned advantageous 1,ω-alkane dicarboxylic acids with one of the above-mentioned advantageous alkanediols are particularly preferably used.

Under biodegradable, it is understood that a compound (here: an aliphatic diblock copolyester) is decomposed under physiological conditions by enzymes and/or microorganisms into smaller degradation products. It is known that aliphatic diblock copolyesters are biodegradable.

It is advantageous if the molar ratio of the polyester block to the polyethylene glycol block is 0.5-1.5 to 0.5-1.5 mol/mol.

In a preferred embodiment, the suspension comprises at least 10 wt.-% and a maximum of 30 wt.-% solid content of diblock copolyester.

This suspension comprising at least 10 wt.-% and a maximum of 30 wt.-% solid content of diblock copolyesters is suitable to optionally comprise a nonionic surfactant.

The suspension comprises, particularly advantageously, 10 wt.-% and a maximum of 30 wt-% solid content of diblock copolyesters, but no added surfactant. The suspensions, with nonionic surfactants, according to the present invention obtained in this way are suitable to be subsequently electrospun.

The addition of a nonionic surfactant to the suspension according to the present invention has a positive influence on its coagulation behavior, as the addition of a surfactant prevents the coagulation.

In one embodiment of the suspensions according to the present invention, arbitrary nonionic surfactants known by persons skilled in the art are suitable to be added in principle. The suspensions, comprising nonionic surfactants, according to the present invention obtained in this way are suitable to be subsequently electrospun.

Suitable nonionic surfactants are known by persons skilled in the art and are suitable to be selected, by way of example, from the group of surfactants comprising (oligo)oxyalkylene groups, surfactants comprising carbohydrate groups and amine oxides. High-molecular nonionic surfactants are hereby to be used, wherein high-molecular surfactants comprise an average molecule mass of at least 50,000 dalton.

Under “(oligo)oxyalkylene” —(OR¹)ᵣ— is hereby to be understood that the surfactants comprising (oligo)oxyalkylene groups are suitable to comprise one or several oxyalkylene groups. In the general formula —(OR¹)ᵣ—, R¹ means an alkylene group, preferably an alkylene group with 2 to 4 carbon atoms, and r means at least 1, preferably 3 to 30. Due to production, r hereby usually represents a mean value of the number of oxyalkylene groups. If r is greater than 1, the residues R¹ in the oxyalkylene groups are suitable to be identical or different.

Surfactants comprising suitable (oligo)oxyalkylene groups are, by way of example, selected from the group comprising surfactants comprising (oligo)oxyethylene groups (polyethylene glycol groups), surfactants comprising (oligo)oxypropylene groups, surfactants comprising (oligo)oxybutylene groups and surfactants which comprise two or more different oxyalkylene groups, by way of example, (oligo)oxyethylene groups and (oligo)oxypropylene groups, in static form or in the form of blocks (blockcopolymerisate), by way of example block copolymerisates on the basis of propylene oxide and ethylene oxide. The surfactants comprising (oligo)oxyalkylene groups are preferably selected from the group comprising fatty alcohol oxylates, alkoxylated triglycerides and polyalkylene glycol ethers alkylated on both sides. Suitable alkoxylates or alkoxylated compounds are, by way of example, ethoxylates, propoxylates, butoxylates or static or block copolymers (or oligomers) composed from two or more different alkoxylates, by way of example, ethoxylates and propoxylates.

Surfactants comprising suitable carbohydrate groups are, by way of example, selected from the group comprising alkylpolyglycosides, saccharose esters, sorbinane esters (sorbitanes), such as polyoxyethylene sorbitane triolate and fatty acid-N-methylglucamides (fatty acid glucamides).

As arises from the group of surfactants mentioned above, the nonionic surfactants which are suitable according to the present invention are suitable to comprise either (oligo)oxyalkylene groups or carbohydrate groups or both (oligo)oxyalkylene groups and carbohydrate groups.

Suitable amine oxides are alkyldimethylamine oxides in particular.

It is possible to use individual surfactants or mixtures of two or several surfactants in the method according to the present invention.

The nonionic surfactants mentioned above are known by persons skilled in the art and are commercially available or are suitable to be produced according to methods known by persons skilled in the art.

The nonionic surfactants used according to the present invention are, in principle, suitable to be contained in such measures in the suspensions according to the present invention which do not lead to coagulation. The optimum measures hereby depend, inter alia, on the surfactant used and the application temperature. The higher the average molecular weight of the surfactant is, the lower its optimum quantity in the suspension. The at least one non-ionic surfactant is preferably used in a quantity of 0.5 to 20 wt.-%, particularly preferably 0.3 to 5 wt.-% with regard to the total weight of the diblock copolyester used. Particularly good results of the procedure are achieved both with regard to the formation of polymer fibers and the quality, e.g. the mechanical stability of the polymer fibers, if 0.3 to 1 wt.-%, preferably 0.5 to 1 wt.-% with regard to the total weight of the suspension of the nonionic surfactant, e.g. of a block copolymer on the basis of various alkylene oxides, e.g. on the basis of propylene oxide and ethylene oxide.

The at least one nonionic surfactant contained in the suspensions according to an advantageous embodiment of the present invention is subsequently added, i.e. after the production of suspensions. In another preferred embodiment of the present invention, the at least one nonionic surfactant is subsequently added to the finished suspension immediately prior to the beginning of the electrospinning method.

The aqueous stable suspensions of biodegradable diblock copolyesters according to the present invention are produced via a method comprising the following steps:
a) Dissolving of particles of biodegradable diblock copolyesters in a polar aprotic solvent,
b) Mixing of this solution with water and subsequent removal of the polar aprotic solvent,
c) Dialyzing of the suspensions obtained from step b) against a water-soluble polymer.

Particles from biodegradable diblock copolyesters are commercially known or are suitable to be self-produced in a manner known to persons skilled in the art. These particles are dissolved in a polar aprotic solvent according to step a) of the method according to the present invention. Suitable solvents are, by way of example, ketones such as acetone, lactones such as 4-butyrolactone, nitriles such as acetonitrile, nitro compounds such as nitromethane, tertiary carboxylic acid amides such as dimethylformamide, urea derivatives such as tetramethylurea or dimethylpropyleneurea (DMPU), sulfoxides such as sulfolane and carbonate esters such as dimethylcarbonate or ethylene carbonate. The concentration of the diblock copolyester in the solvent is advantageously 2 to 10 wt.-%, particularly preferable 4 to 5 wt.-%.

This solution is then mixed with water. Water is thereby suitable to be provided and the polymer solution from step a) to be added or vice versa, or the water and the diblock copolyester solution are suitable to be mixed with one another continuously. The diblock copolyester solution and water are advantageously mixed with one another in a ratio of 2:1 to 1:2 (V/V). 1 to 5 mg of a polyalkylene glycol ether (fatty alcohol ethoxylate) is optionally added to the water prior to mixing with the polymer solution, e.g. polyoxyethylene (20) stearyl ether (Brij 78®). The polar aprotic solvent is subsequently removed.

Finally, the aqueous polymer suspension from step b) is dialyzed against a water-soluble polymer. Suitable water-soluble polymers are, by way of example, polyvinyl alcohol, polyethylene oxide, polyethyleneimine, polyalkylene glycols such as polyoxyethylene (20) stearyl ether (Brij 78®) and cross-linked polyacrylic acids or their salts. Cross-linked polyacrylic acids and their salts are also known as superabsorbers.

Diblock copolyester solution and water-soluble polymers are advantageously mixed in a ratio of 1:5 to 1:30 (V/V).

The aqueous suspensions of biodegradable diblock copolyesters obtainable in this way comprise dispersed copolyester particles with diameters of some 10 nm to 300 nm. The suspensions are stable at room temperature over a period of several weeks. The solids content in the aqueous suspension according to the present invention amounts to at least 10%. This is surprising, because a stable aqueous suspension cannot be achieved via dialysis of very similar triblock copolymers, and a suspension with such a high solids content is not obtained in this case.

The stable secondary aqueous suspensions according to the present invention essentially comprising water-insoluble biodegradable aliphatic diblock copolyesters are suitable to be used in an electrospinning method for the production of nano- and microfibers as well as nano- and microfiber wovens with non-oriented or oriented fibers.

Nanofiber woves are wovens whose fibers comprise diameters of 10 nm to below 1,000 nm, while fibers in microfiber wovens comprise diameters of 1 μm to 10 μm.

Electrospinning is known per se. A solution of the polymer that is to be spun is hereby exposed to a high electric field at an edge serving as electrode. By way of example, this is suitable to take place by extruding the solution to be spun in an electric field via an electrode, e.g. a cannula or roller, connected to a pole of a voltage source. A material flow directed toward the counter-electrode is obtained, which solidifies on its way to the counter-electrode. This thereby results in an non-oriented fiber nonwoven.

In addition to the polymer or polymer mixture, the spinning solution is also optionally suitable to comprise other components.

During the spinning process, a frame made of a conductive material, for example a rectangular frame, is suitable to be inserted between the nozzle and the counter-electrode. In this case, the fibers are deposited on this frame in the form of an oriented nonwoven. This method for the production of oriented meso- and nano-fiber nonwovens is known to persons skilled in the art and is suitable to be utilized without exceeding the scope of protection of the patent claims.

In general, flimsy materials or fabrics made of textile or non-textile staple fibers or filaments whose cohesion is provided by its own adhesion to the fibers are characterized as nonwovens.

“Filament” is thereby the term for fibers with an essentially unlimited length. Fibers obtained from filaments via cutting are characterized as staple fibers.

“Nonwovens on the basis of electrospun fibers” are understood to be nonwovens according to the above definition whose fibers have been produced using the known electrospinning method. The nonwovens based on electrospun fibers are suitable to comprise one or more layers and are suitable to be non-oriented or oriented with regard to their principle axis against one another. These nonwovens on the basis of electrospun fibers are optionally suitable to be complemented with other substances.

In another embodiment, the electrospun nonwovens have a fabric-like structure. “Fabric-like” hereby means that several nonwoven layers are layered on top of one another, wherein each layer is positioned in a rectangular manner to the layer above and below it. However, the fibers are not interlaced as they would be for “real” fabrics. In fabric-like nonwovens, any number of layers are suitable to be layered on top of one another.

Stable secondary aqueous suspensions according to the present invention comprising water-insoluble biodegradable aliphatic diblock copolyesters comprising 1 wt.-% to 25 wt.-% of diblock copolyester are advantageously spun. In doing so, the diblock copolyester used has to comprise a melting point of between 35° C. and 70° C., and an amount of 2 to 10 wt.-% of a water-soluble polymer has to—with regard to the entire spinning solution—be added to the electrospinning solution. Suitable water-soluble polymers are poly(ethylene oxide) (PEO), poly(vinyl alcohol) (PVA), polyacrylamide (PA) and poly(vinyl pyrrolidone) (PVP). If the water-soluble polymer is PVA, PA or PVP, amounts of 2 to 10 wt.-% of this water-soluble polymer in the spinning solution allows for electrospinning to be implemented effectively, independent of the average molecular weight of this water-soluble polymer. If the water-soluble polymer is a poly(ethylene oxide), then the more its average molecular weight is, the less PEO is advantageously used. By way of example, the amount of PEO 900,000 should be <4 wt.-% in order to ensure that the electrospinning solution is electrospun effectively. In contrast, spinning solutions that comprise 2 to 10 wt.-% of PEO 300,000 are suitable to be electrospun effectively. The amount of wt.-% of a particular poly(ethylene oxide) in the spinning solution required to lead to effective electrospinning is suitable to be found out very easily by persons skilled in the art without exceeding the scope of protection of the patent claims.

These water-soluble polymers are suitable to be selectively extracted after production of the fibers without disintegrating the fibers with water. In doing so, it has to be stressed that the fibers should not swell during this extraction. Fibers produced from suspensions according to the present invention via electrospinning are stable when water-soluble polymers are present in low quantities in case of water contact at temperatures of up to 40° C., i.e. fiber form, fiber dimension and mechanical stability of the fibers essentially remains unchanged. Low quantities of water-soluble polymers are understood to be quantities of up to 10 wt.-% with regard to the weight of the fibers.

The melting point of 35° C. to 70° C. for the diblock copolyesters is important because the suspension particles elapse into one another in the fibers forming during the electrospinning and are thereby suitable for forming homogeneous fibers. “Homogeneous fibers” hereby means that the individual particles in the fibers are almost no longer recognizable. Such fibers are more mechanically stable than non-homogeneous fibers, wherein the individual particles are still recognizable. Polymers which melt at room temperature or below are also less suitable for electrospinning because the forming fibers simply run in this case.

The diameter of the fibers being obtained is preferably 10 nm to 10 μm. Fiber diameters of between 50 nm and 900 nm are particularly preferred.

The nano- and mesofiber nonwovens according to the present invention comprise a surface of 5 to 1,000 g/m² and diameters of 10 nm to 2 μm and lengths of 1 μm to up to several meters. Diameters of 10 nm to 1 μm are preferred.

It is known to persons skilled in the art how to set the fiber diameter. By way of example, the more viscous, i.e. the more concentrated the polymer solution to be spun is, the larger the fiber diameter becomes. The higher the flow rate of the spinning solution is per time unit, the greater the diameter of the electrospun fibers obtained. Furthermore, the fiber diameter depends on the surface tension and the conductivity of the spinning solution. This is known to persons skilled in the art, and they can use this knowledge without exceeding the scope of protection of the patent claims.

The nano- and mesofibers according to the present invention and nano- and mesofiber nonwovens are suitable to be used in medicine, pharmaceutics and agriculture. As such, they are suitable to be used, by way of example, for the production of implants and bandages, as well as a substitute fabric material, for the release of pharmaceuticals and pheromones, or for the release of biocidal, fungicidal and insecticidal active agents.

The dispersed biodegradable diblock copolyesters are suitable to be used as biodegradable viscosity modifiers and/or compatibilizers in blends, as glues, as varnishes, as paper additives, flame retardants, impact modifiers and hazers of transparent plastics, and for the production of biodegradable sheets, films, fibers, plates, vessels, tubes and capillaries for transport or packaging purposes.

The state of the art knows numerous methods for the production of fibers made of polymer suspensions via electrospinning. The present invention differentiates itself from the state of the art because it provides secondary suspensions for the first time ever and uses secondary suspensions of biodegradable diblock polymers in particular which until now have not been available with a sufficient solid content; until now, only suspensions with a solid content of max. 2 wt.-% have been obtainable, while the present invention provides suspensions with a solid content of over 10 wt.-%.

### LIST OF REFERENCE NUMERALS

1 Voltage source
2 Capillary nozzle
3 Syringe
4 Spinning solution
5 Counter electrode
6 Fiber formation
7 Fiber mat

### FIGURE LEGENDS

FIG. 1

Particle size distribution of the copolyester suspension (PHA-MPEG, 2.5 wt.-%), d=109 nm, PDI=0.109, measured via DLS (dynamic light scattering).

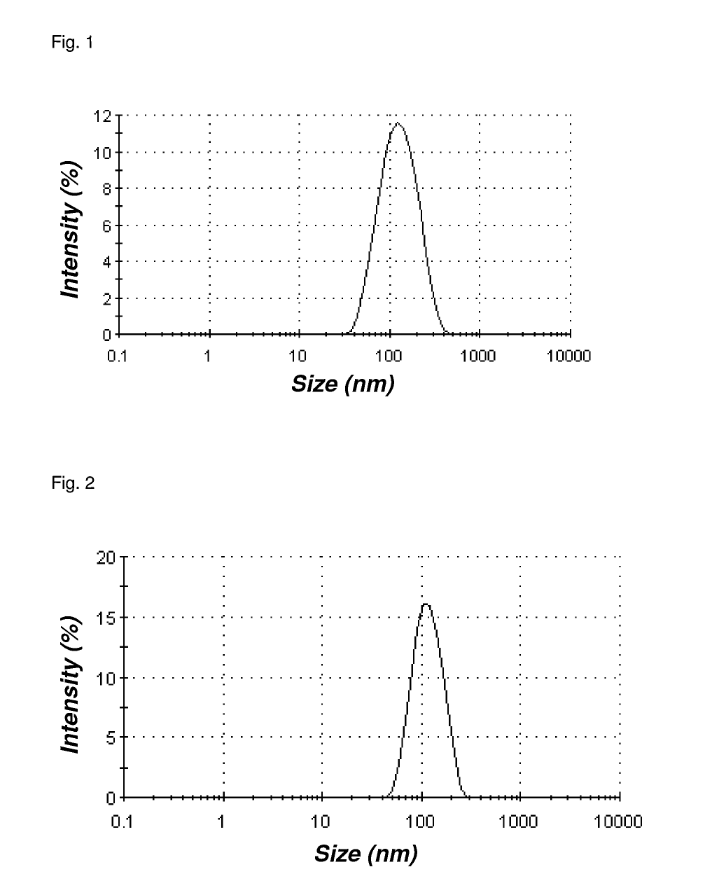

FIG. 2

Particle size distribution of the concentrated copolyester suspension (PHA-MPEG, 16 wt.-%), d=108 nm, PDI=0.115, measured via DLS (dynamic light scattering).

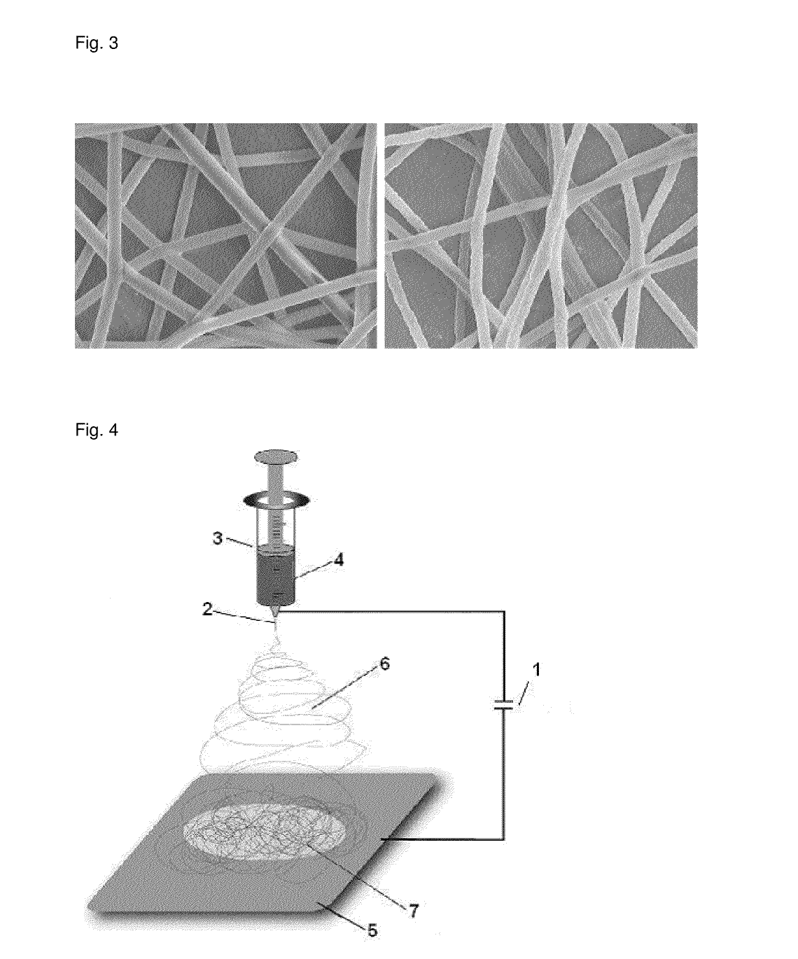

FIG. 3

Electrospun diblock copolyesters/PEO composite fibers such as electrospun (left) and diblock copolyester fibers after water treatment (one hour at 20° C.) (right) measured via DLS (dynamic light scattering).

FIG. 4

FIG. 4 shows a schematic representation of a device suitable for carrying out the electrospinning method.

The device comprises a syringe 3, at the tip of which a capillary nozzle 2 is located. This capillary nozzle 2 is connected to a voltage source 1 with a pole. The syringe 3 takes up the solution 4 to be spun. A counter electrode 5 is connected to the other pole of the voltage source at a distance of approx. 20 cm opposite the exit point of the capillary nozzle 2; this functions as a collector for the formed fibers.

During the operation of the device, a voltage of between 18 kV and 35 kV is applied to the electrodes 2 and 5, and the spinning solution 4 is discharged through the capillary nozzle 2 of the syringe 3 under low pressure. Due to the electrostatic charge of the polymer molecules in the solution resulting from the strong electric field of 0.9 to 2 kV/cm, a material flow directed toward the counter electrode 5 occurs, which solidifies on the way to the counter electrode 5 resulting in fiber formation 6, as a result of which fibers 7 with diameters in the micro- and nanometer range are deposited on the counter electrode 5.

### PRACTICAL EMBODIMENTS

### Practical Embodiment 1

### Synthesis of the diblock copolymer polyhexylene-adipate-block-methoxy-polyethylene glycol (PHA-b-MPEG) (1:1)

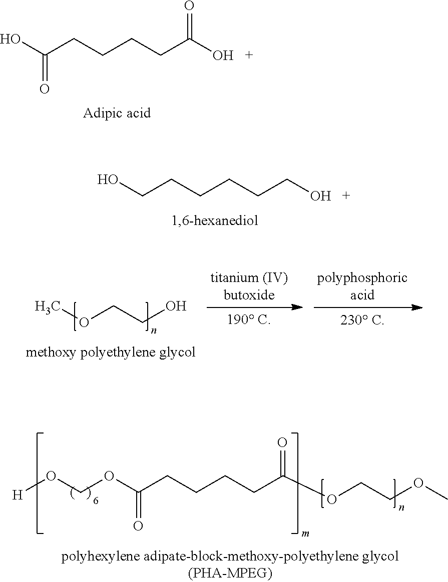

Chemicals:

| | | | | | | |
|---|---|---|---|---|---|---|
| Adipic acid | 146.14 | g/mol | 0.779 | mol | 113.8 | g |
| Hexanediol | 118.18 | g/mol | 0.779 | mol | 92.03 | g |
| MPEG 5K | 5.000 | g/mol | 6.84 | mmol | 34.2 | g |
| Titanium butoxide | 340.32 | g/mol | 0.23 | mmol | 0.078 | ml |
| Polyphosphoric acid | 98 | g/mol | 0.44 | mmol | 0.043 | g |

Execution:

In a well-preheated 1 l three-necked flask, the adipic acid, the 1,6-hexanediol and the polyethylene glycol were provided. The transesterification catalyst titanium(IV) butoxide was added via syringe. The reaction was heated to 190° C. in the salt bath and maintained at this temperature until the theoretical amount of water was almost completely distilled off (approx. 5 h, 27 ml). In the second reaction stage, the polyphosphoric acid was added as a means of condensing, the temperature of the salt bath was increased to 230° C., and, with the help of an oil pump, a high vacuum was slowly applied to the reaction. The reaction was subsequently left to react for another 40 h. This resulted in a brown, highly viscous polymer.

The polymer was dissolved in approx. 1 l of THF and precipitated in 5 l of hexane. The precipitate was removed by filtration and dried in the membrane pump vacuum.

### Practical Embodiment 2

### Dispersion of the Synthesized Diblock Copolyesters (PHA-b-MPEG) (1:1)

25 g of copolyesters from embodiment 1 was dissolved in 625 mL of acetone and added to the solution Brij®78 (2.5 mg in 1 l water). The mixture was treated for 4 min with ultrasound (30 W) and left in a hood for 24 h until the acetone had evaporated completely. 1 l of polymer suspension was produced (2.5 wt.-%). If the water of the suspension is left to further evaporate, the suspension is suitable to be concentrated up to 3 wt.-%. The suspensions were measured without filtration with DLS.

The particle size distributions are shown in FIG. 1.

### Practical Embodiment 3

### Dialysis of the PHA-MPEG Suspension

Polyvinyl alcohol was used for the dialysis, and a dialysis tube (MWCO=12-14,000; diameter=76 mm) was utilized in order to produce the concentrated suspension.

The dialysis tube was filled with 500 mL of polymer suspension and dipped into approx. 6 l of PVA solution. The copolyester dispersion was dialyzed at room temperature for 100 hours. In doing so, the weight loss of the polymer suspension was measured at different points in time, and the concentration of the polymer suspension was calculated. The final concentration amounted to 16 wt.-%.

Prior to and after dialysis, the particle sizes and the particle size distribution were examined with the help of the PCS. No aggregation was observed.

FIG. 2 shows the diagram with regard to the particle size distribution after the dialysis.

### Practical Embodiment 4

### Electrospinning of the Concentrated Diblock Copolyester Suspension (16 wt.-%)

The concentrated diblock copolyester suspension (16 wt.-%) was mixed with a solution of polyethylene oxide (3 wt.-% in water) and electrospun at a feed of 0.05 mL/min, with an electrode gap of 15 cm at a voltage of 15 kV using aluminum foil as a counter electrode.

The fibers obtained were subsequently treated with water for one hour at 20° C.

FIG. 3 shows the fibers obtained immediately after spinning (left) and after treatment with water for one hour (right).

### Practical Embodiment 5

### Production of a Self-Stabilized PHA-b-MPEG Suspension

25 g of the copolyesters from embodiment 1 was dissolved in 625 mL of acetone and added subsequently under stirring to 1 l of distilled H₂O. The mixture was then treated under stirring for 4 min at 40 W with ultrasound, before the acetone was evaporated for 48 h at RT.

To concentrate the suspension, 500 mL of the solution was filled into a dialysis tube manufactured by the company Spektra Por, and the latter was dipped for 100 h into 2 l of an aqueous Mowiol 8-88 solution (15 wt.-%). The solid part in the suspension was suitable to be increased up to 25% by means of a two-day dialysis of the solution (approx. 14 wt.-%); in a “fresh” Mowiol 8-88 solution (15 wt.-%, 2 l), the solid part in the suspension was suitable to be increased up to 26%.

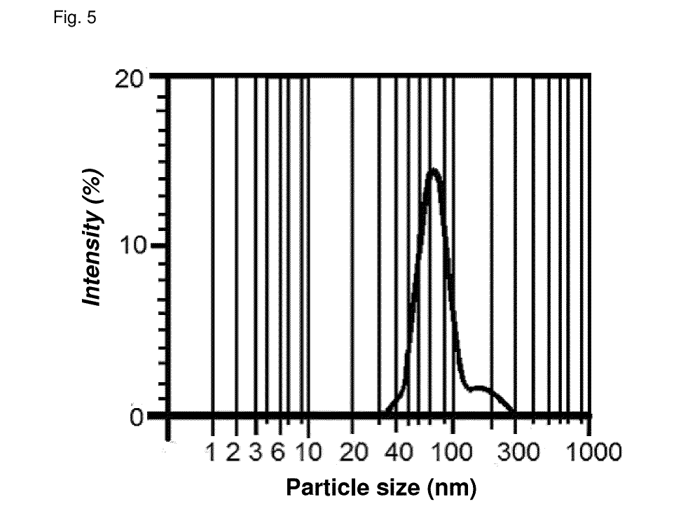

Particle sizes: 72 nm and 164 nm, see FIG. 5.

### Practical Embodiment 6

### Electrospinning of the Self-Stabilizing PHA-b-MPEG Suspension with Different Weight Percentages of PEO

Different weight percentages of PEO were added to the self-stabilizing PHA-b-MPEG suspension form embodiment 5 and subsequently electrospun.

Amounts of PEO 900,000 used in percent by weight with regard to the suspension:
3.5 wt.-% PEO (only barely suitable to be electrospun due to the high viscosity)
2 wt.-% PEO
Amount of PEO 300,000 in percent by weight used:
3.5 wt.-% PEO
2 wt.-% PEO

The PEO was directly dissolved in the suspension. In the case of the high-molecular matrix polymer PEO 900,000 and the high concentration (3.5 wt.-% PEO with regard to the suspension), the solution was only barely suitable to be electrospun.

Electrospinning/spinning parameters:
Voltage U (above)=15 kV
Voltage U (below)=10 kV
Distance between the electrodes: 22 cm
Feed 0.5 mL/min

1. A stable secondary aqueous suspension comprising at least one water-insoluble biodegradable aliphatic diblock copolyesters according to formula (I) 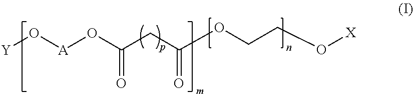
wherein
A is a linear or branched alkyl group with 3 to 12 carbon atoms,
p is 1 to 14,
m is 10 to 500,
n is 10 to 500,
X is H, an alkoxide, a linear, branched or cyclic alkyl group with 1 to 20 carbon atoms or a phenyl group,
Y is H, an alkoxide, a linear, branched or cyclic alkyl group with 1 to 20 carbon atoms, a carboxylate, a carboxylic acid residue, an ester, a thioether,
and wherein
the at least one diblock copolyester comprises one block of an aliphatic polyester and one block of a polyethylene oxide, and
the solid content of the at least one diblock copolyester in the suspension amounts to at least 10 wt. %, and
the melting point of the at least one diblock copolyester is between 35° C. and 70° C., and
the mass of the polyethylene oxide block in the at least one diblock copolyester amounts to between 500 and 10,000 dalton.

2. The stable secondary aqueous suspension according to claim 1, wherein Y is a linear, branched or cyclic alkyl group and X a linear, branched or cyclic alkyl group or a phenyl group.

3. The stable secondary aqueous suspension according to claim 1, wherein the aliphatic ester is an ester of an 1,ω-alkane dicarboxylic acid selected from the group consisting of malonic acid, succinic acid, glutaric acid, adipic acid, pimelic acid, suberic acid, azelaic acid, sebacic acid, dodecanoic acid, brassylic acid, and tetradecanoic acid.

4. The stable secondary aqueous suspension according to claim 1, wherein the aliphatic ester is an ester of an alkanediol selected from the group consisting of 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, and 1,12-dodecanediol.

5. The stable secondary aqueous suspension according to claim 1, wherein the size of the polyethylene glycol block amounts to 500 to 10,000 dalton.

6. The stable secondary aqueous suspension according to claim 1, wherein polyester and polyethylene glycol blocks are present in a molar ratio of (polyester block:polyethylene glycol block) of 0.5 to 1.5:0.5 to 1.5.

7. The stable secondary aqueous suspension according to claim 1, wherein the solid content is at least 10 wt. % and a maximum of 30 wt. %.

8. The stable secondary aqueous suspension according to claim 6, wherein the suspension additionally comprises a nonionic surfactant.

9. Method to produce A method of producing the aqueous stable copolyesters suspension according to claim 1, the method comprising:
(a) dissolving particles of the biodegradable diblock copolyesters in a polar aprotic solvent to form a solution;
(b) mixing the solution with water and subsequently removing the polar aprotic solvent to form an intermediate suspension; and
(c) dialyzing the intermediate suspension obtained from step (b) against a water-soluble polymer to form the aqueous stable suspension.

10. (canceled)

11. (canceled)

12. (canceled)

13. (canceled)

14. (canceled)

15. A method of making a fibrous product, the method comprising:
(a) mixing the stable secondary aqueous suspension of claim 1 with an electrospinning solution, the solution comprising about 2 wt. % to about 10 wt. % of a water soluble polymer;
(b) electrospinning the mixture obtained in step (b) to form fibers having a diameter of about 10 nm to about 10 μm.

16. The method of claim 15, further comprising (c) selectively extracting the formed fibers with water.
